(19) United States
(12) Patent Application Publication
(10) Pub. No.: US 2023/0132399 A9
(43) Pub. Date: Apr. 27, 2023

(54) Method and System for Notation and Grouping of Messages Stored on a Mobile Device

(71) Applicant: Oliver Wendel Gamble, New York, NY (US)

(72) Inventor: Oliver Wendel Gamble, New York, NY (US)

(21) Appl. No.: 17/490,077

(22) Filed: Sep. 30, 2021

Related U.S. Application Data
(63) Continuation-in-part of application No. 15/412,497, filed on Jan. 23, 2017.
Application No. 15/412,497 is a continuation-in-part of application No. 14/541,132, filed on Nov. 13, 2014, now Pat. No. 11,532,017.
(60) Provisional application No. 61/962,697, filed on Nov. 13, 2013.

(51) Int. Cl. H04L 51/52; H04L 51/58; H04L 51/04; H04L 51/224; H04L 51/066

(52) U.S. Cl. CPC H04L 51/32; H04L 51/38; H04L 51/04; H04L 51/24; H04L 51/066

(57) ABSTRACT

A messaging system with methods for adding descriptive notes to Emails and Text Messages stored on a mobile device. Enabling the user of the mobile device to enhance the value content of messages stored on the mobile device. Enabling the user of the mobile device to associate un-related messages stored on their mobile device. By being able to add information to a text message that have been conveyed to the user by annotation of received Email or Text messages.

The present application claims the benefit of priority of patent application Ser. No. 14/541,132 entitled “Method and System for Interactive Notation on a Mobile Device,” filed on Nov. 13, 2013, patent application Ser. No. 15/412,497 entitled “ Method and System for Interactive Notation, Text Data Storage and Management on a Mobile Device,” filed on Jan. 23, 2017, and patent application Ser. No. 16/718,124 entitled “Method and System for Notation of Messages Stored on a Mobile Device,” filed on Dec. 17, 2019, the disclosures of which are hereby incorporated by reference in their entirety for all purposes.

Before the present methods and systems are disclosed and described in this patent, it is to be understood that the methods and systems are not limited to specific methods, specific components, or to particular implementations. It is also to be understood that the terminology used herein is for the purpose of describing particular embodiments only and is not intended to be limiting to the scope of the patent.

### BACKGROUND OF THE INVENTION

It so often happens that you receive a piece of information that has a lot of significance, but with the passing of time and interactions with the process of life the importance of something communicated can fade. It would be nice if we could Annotate messages with information that we think is important to a received or sent message.

The ability to annotate messages will enable mobile device users to add future value to their received and sent email and text message communications. This ability increases the value of saved messages, by clearly defining your opinions for future reference. By enabling the user to review their thoughts in a written form from the time of the message inception on the mobile device. Breathing new life into memories of feelings and opinions that may have faded over time.

### FIELD OF THE INVENTION

The present invention relates generally to a method and system for improving the ability to understand information contained in an email or text message sent or received on a mobile device. Traditional email and text messages contain information that is accessible on a mobile device via two distinct applications. Emails on a mobile device are accessible primarily via an Email Service Providers such as Outlook, AOL, Gmail, or Yahoo. Mobile device users have Email account(s) that is username and password protected. From any computer, anywhere in the world the user can access their Email via a computer with Internet access, a browser, and Email Service Provider Application software (on the mobile device or on the Internet). Text Messages are similar and yet different. A Text Message is targeted to a specific mobile device, via its phone number. A user can receive a Text Message directed to them only if they have a phone with the correct phone number. A user cannot access a Text Message on any phone, they must have a phone with the exact phone number that the Text Message is directed to. Therefore, one would need to use two different types of applications to access the contents of their Text Messages and Emails.

The term E-communication shall refer to incoming text messages, incoming email, and outgoing text messages that are sent and received by a mobile device. E-communications are captured and stored in searchable fields of a record in a table in a database. Each Ecommunication is individually stored in a record, each record has fields for storing the contents of the E-communication that is referred to as the message body field and extra fields for storage of other contents.

If sufficient time has passed since receiving or sending of said message (Ecommunication), there may be a lack of clear memory of the message significance or location on a mobile device: one may not remember if the sought-after information was in a text message or an email. The more messages that are accumulated and more time that passes the dimmer one's memory can become on the facts or import of a piece of information sitting on a mobile device.

What is needed is a method for better storing and management of information communicated to a person on a mobile device. The ability to add detail notation on any desired message and/or create links between important messages regardless of origin.

### SUMMARY OF THE INVENTION

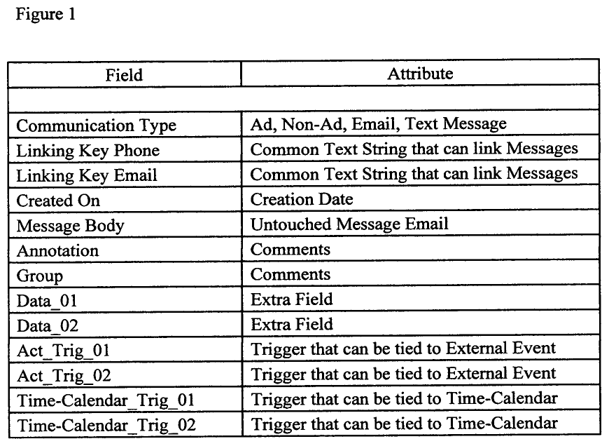

Accordingly, an improved system and method of message management on a mobile device is desirable. The ability to selectively tag and/or annotate any message stored on a mobile device is a leap forward. To achieve this goal, each E-communication is stored individually in a record in a table in a database by an Application. Each received message is individually parse into various fields in said record by said Application. Each record is stored in the table, and said record has fields for all of the elements of an E-communication message and a few extra fields. One of the extra fields is labelled Annotation (see FIG. 1), and it can hold a large block of alphanumeric text: a word, a string of words, or a large paragraph. Another one of the extra fields is labelled Group (see FIG. 1), and it can hold one or more strings of alphanumeric text.

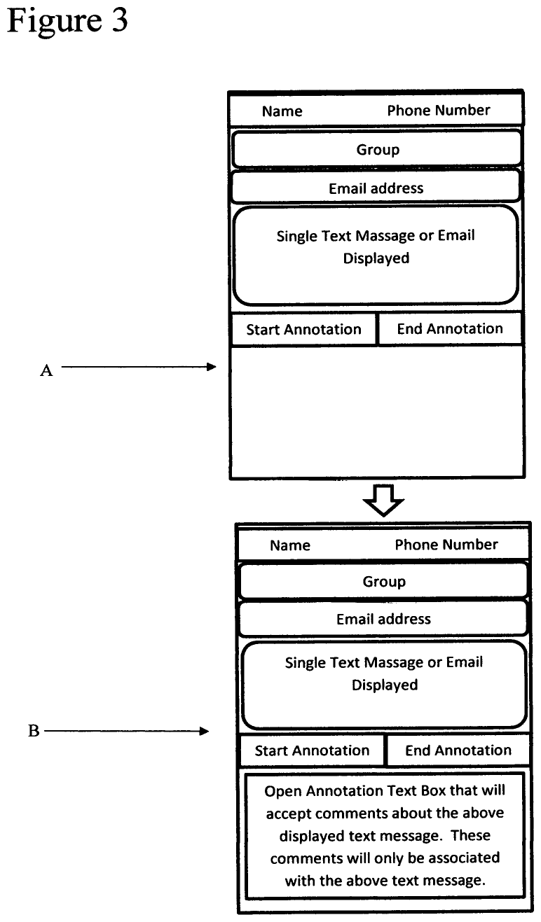

The Annotation and Group fields are accessible to the user for editing and storing a textual message. The contents of the Annotation, the Group field, and that of the of Ecommunication fields stored in a record can be viewed at the same time when a user is reviewing their messages using the Application (FIG. 3). The user can also search the alphanumeric contents stored in Annotations field of each record by entering a search criterion in a search field, enabling the user to see any message whose Annotation field contain a match to the searched upon criterion. Similarly, the user can execute a search of the contents stored in the Group field in record by entering a search criterion in a search field, enabling the user to see any message that has the same string contents stored in the Group field as the search criteria entered by the user.

Mobile devices have a “Listen” function that allows a programmer to screen for incoming and outgoing text messages. This function can be used to capture the contents (body) of incoming and outgoing text messages along with supplemental information such as date, time, and origin. The “Listen” function can also be used in conjunction with the “Email Notification” function making possible the detect and capture incoming Emails and store them in a record of a table in a database. This process will eliminate the need for password or user ID to access and store the Incoming Email: no hacking required.

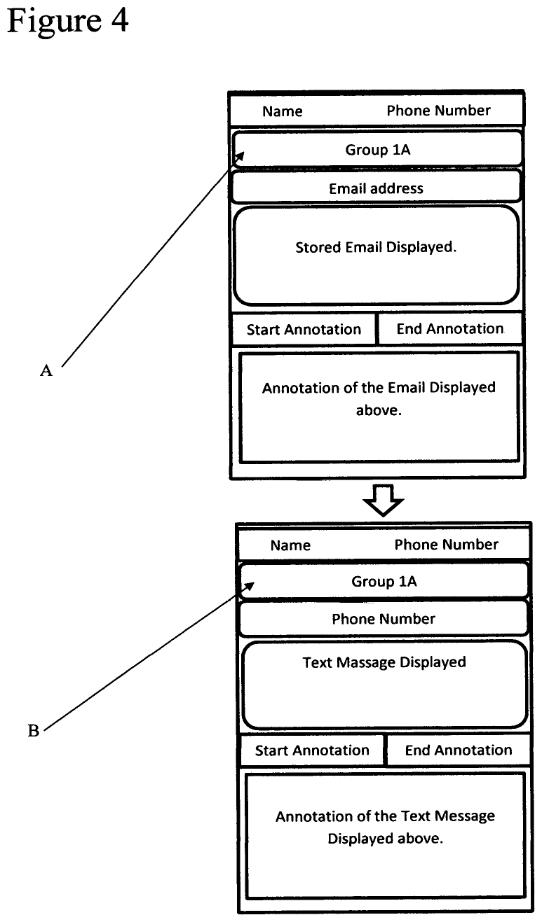

Storing Emails and text messages (incoming and outgoing) in fields of a single table will allow the user to perform searches of both the text messages and the email from a single Application. One type of search can be executed on the “Group” field of the records to create a collection of records that the user feels are related and significant. Another type of search can be executed on the “Annotation” fields to find messages that relate to a specific subject matter. Being that the user can add notation on the content of any stored message, the user can add greater details about their opinion of the matter in the save message. This will be an added benefit to the user in enabling them to better review the contents of their stored messages in the database stored on their mobile device at some time in the near or distant future (FIG. 4). The Group field can be used to store a common alphanumeric string of text that can serve as a tag that is placed in several unrelated records that are stored in a common searchable database. A search of said Group field of the records in said database using said common alphanumeric string of text will allow the Application to group all of the unrelated records the user placed the said alphanumeric string of text in the said “Group” field. In effect the user is able to create a relationship (a common link) between the unrelated stored messages regardless of their origin or original form (email or text message).

### DETAIL DESCRIPTION OF THE INVENTION

An application that is loaded on to/into a mobile device contains a database, that contains tables, which are composed of records. Each record contains a variety of fields similar to that of FIG. 1. Once the application is installed, each sent and received email and text message will be stored in fields of an individual record. Each message can be detected by the install application, by setting the Event Listener to detect email and text message activity. Once activity is detected, the message can be captured and stored in fields of a record in a database. Once both E-Mail and Text Messages are both stored in a single database, this database of mails and text messages will be referred to as E-Communications Database. The fields into which the contents of an E-Communication are stored is both searchable and editable. The user of the application can access and enter information in the form of alphanumeric text into the fields denoted as “Annotation” or “Group” (see FIG. 1 and FIG. 4) in each of the records in the E-Communication Database.

Detection of email or Text Message activity is achieved by utilizing the Listen function, once detected the application will trigger it's capture and convergence process that will convert said detected E-communication into strings and store them in fields of a record. All records are stored in a table, and each record is viewable by the user, allowing the user to view all the Ecommunications captured and saved in the fields of records, one record at a time. There are fields in the record for the various components of the saved E-communication, and search of the stored Ecommunication records can be executed on a single field alone or in concert with another field (i.e., search by sender, by date, by sender and date, by subject, by body, by sender and subject, and by date and subject and by sender). When a text message is sent or received it is converted into a string and stored in the “Message Body” field of the record. The record is stored in a table that is viewable by the user, allowing the user to view all received and sent text message in various orders (i.e., by sender, by date, by body, by sender and date, by receiver, and by receiver and date). While viewing a stored message (email or text message), the user can click on a button to access a text box that stores whatever is written in it to the first annotation field (“Annotation”). When they have finish entering notes the user presses an indication to signal finish and the contents are saved and the text box is closed. From this point on, whenever the user views the stored message, they will also see the contents if any stored in the Annotation field. This association and auto-viewing of message and annotation will serve to refresh the viewer's memory on what was at a time considered important to understanding the E-communication/message. Being that both the annotation and contents of the body of the E-communication are viewed together, one can execute a search of the Annotation field and see the related message(s). Because the messages are stored as records in a database format of searchable fields in a table, it is possible for the user to search the table for specific message(s), or to display the search results for messages in a specific order.

In another embodiment, E-communication can be any message that can be detected by the listening process described, and then stored as alphanumeric text/strings in fields of a record, in a table that is both editable and searchable. Said table can be also considered a database when they are stand-alone: one table does make a database.

In the mobile device messages are stored in records that have fields that are specifically created to contain the contents of a message (text message or email), and fields that are blank user editable. These blank editable fields are created to hold a user entered tag. The tag can be either a single alphanumeric string, or a group of alphanumeric strings entered by the user and stored in the field. This field can be referred to as a “Group” or “Relational” field. In the application the user can execute a search on a variable that contains a specific alphanumeric string(s), matches to the alphanumeric string(s) contained in the “Group” (a.k.a. “Relational”) field will be displayed to the user. If the user were to enter the same alphanumeric string in a group of records containing stored messages, then the user will be able to execute a search that will return/display the messages (records) that have the same alphanumeric content in their “Group” field. This will enable the user to group un-related messages regardless of their origin or nature (text message or email). The user will be able to create relationships between messages by storing the same alphanumeric string in any message “Group” field. Being able to create grouping/relationships between records will allow the user to organize the messages on the mobile device in unique collections, creating distinctly personal perception of how information stored on the mobile device is perceived.

FIG. 3 has two components. The components are labelled “A” and “B”. In component “A” we see a representation of a mobile device screen with a display area for a message content of either an email or a text message to be viewed. The message content can be either a sent or received message of an email or text message. Under the message display area is two buttons, one for starting the “Annotation process” and the other for ending the “Annotation process”. When the mobile device user presses the “Start Annotation” button, a text box will open on the screen. The user will be able to type in any message they want regarding the message. This message will be stored in the “Annotation” field of the record.

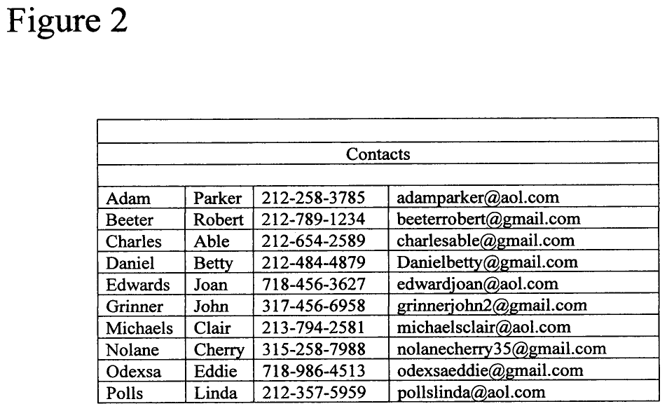

In one embodiment, the result of a search of the stored text message and email can be displayed in one of three different modes. The user can indicate whether they want the results of a search of the stored information in the table that match the search criteria to be of email only, text messages only, or a combination of both text messages and emails. Search criteria other than phone number and email can be searched for utilizing standard field procedure to search the records stored in the table of records that the communications are stored in. However, a search of the stored communications in the table by either the phone number or email address will require preprocessing of the records. The preprocessing will consist of using a table that has both the phone number and email address, such as a contact table. Utilization of said table, contact database or a similar database, that contains both phone number and email address can be used to allow the application to perform searches base on phone number or email address as search criteria. It would be possible to display email and text messages mixed together by allowing the text messages to look up the name and email of the sender and store it in a field of the record, or allow the email to look up the phone number of the party the mail is addressed to using the mobile device contact database and store that information into a field in the table (i.e., the “Linking Key” fields). FIG. 2 is representative of the Contact list in a mobile device. It contains the name, phone number and email address of the contacts. The Application would take an email sender's address and look it up in the Contact list, and if found the Application would take the associated phone number and place it in the “Linking Key Phone” field. This process will allow all email to be associated with the text messages that come from the same location as identified by phone number. The reverse can be done for text messages, where the Contact list is used to look up phone numbers to fine the associated email address, and place said email address in the “Linking Key Email” field of received emails. Received emails have their address normally stored in the “Linking_Key_Email” field, and text message normally have their origin phone number stored in the “linking_Key_Phone” field.

The Application enables the user to perform searches of the table of stored E-communication with a selection of search criteria. The user can search with such fields as Name, alphanumeric string, Date, Grouper (aka Group field), Phone Number, and Type (Text Message or Email). The user can search the stored E-communications using any one of the above cited criteria or a combination of said criteria.

In an alternative embodiment, other types of transmitted alphanumeric messages can also be captured and stored in fields of a record in a table. If the mobile device is able to capture the incoming messages as it does the email and text, then the Application can incorporate other forms of E-communication.

The “Communication Type” field can be used to allow the mobile device user to search, view, and annotate only emails or only text messages at a given time. The user can use the “Communication Type” field to selectively search, view, and annotate only email messages stored in records in the table; or only search, view, and annotate only text messages stored in the records in a table: Emails vs Text Messages.

The number of email accounts that can be handled by the application is not limited to one. The listening function of the application can detect email activity from a variety of email platforms: G-Mail, AOL, Outlook, and others. This capability will enable the application to capture and store user emails from their accounts on various email platforms, they can even capture emails from several accounts on the same platform. If the user has two G-mail accounts (one personal and one business/professional), the user will be able to monitor incoming from both accounts along with their (incoming and outgoing) text messages. This will also work for a user that has two G-mail accounts and 1 or more AOL or Outlook account. The application will enable a user to capture and save all detected incoming email and incoming/outgoing text messages in one place. The detected text messages and emails (E-communications) will be stored in fields of a record in a table of a database. These stored E-communications are stored in records that are searchable and have fields that can be used to store annotation or alphanumeric texts that can be used to randomly link records by the sharing of a common string of alphanumeric text characters. In FIG. 4, the application is displaying two different records stored in the database. One record is of a Text Message and the Other is of a Text Message, and both records have the same alphanumeric string in their “Group” field: Group 1A. When the user executes a search of the database using “Group 1A” as a search criterion (variable), the application will return both the email and text message for viewing. This is how the application can link un-related stored E-communications records.

The “Time-Calendar_Trig_01” field is a field that can hold a date and time which when compared to the mobile clock current date and time will generate a “Yes” or “No” reply in the software coding. If the value stored in the Time-Calendar_01” field matches the date and time of the mobile device current date and time a “Yes” is generated, and the yes will trigger a “course of action”. If the mobile device current date and time does not match the value stored in the TimeCalendar_Trig_01 field, the Application code will generate a “No” and no course of action will be executed. Using the “Time-Calendar_Trig_01” field in the record, it is possible for the user to store a date and time in the record, and have the Application sound an alert when the clock of the mobile device indicates that that time has arrived. The Application user will be able to see the record with the date and time that triggered the alert (course of action), said record contained stored message and any notes on the message, and any Group tag linking other messages. When the mobile device clock calendar reaches the date-time set and stored in the record, an alert will be triggered, causing the Application to sound an audible tone/vibrate while the contents of the stored message will be displayed. If the message is tagged (alphanumeric string in the Group field), then associated messages (all records containing a message with the same alphanumeric string in their Group field) will also be gathered for displayed to the user. This will enable the user to preset a time and date in the Application to address specific communications stored in the database that they are interested.

The “Time-Calendar_Trig_02” field is a backup field, a field that the user can enter a secondary date and time for notification. This backup alert notice will give the Application user a second chance to set up an alert notice.

FIG. 1 is a prototype listing of fields of a record that is used to store individual sent and received emails and text messages.

FIG. 2 is representative of the Contact list in a mobile device.

FIG. 3 is a representation of a text message with Annotation.

FIG. 4 is a representation of a text message and an email with the same group string “Group 1A”.

1. A mobile device message notation management system comprising: a memory and at least one processor coupled to the memory, wherein the at least one processor is configured to execute instructions stored in the memory to cause said apparatus to; capture and store E-communication in editable fields of a record of a searchable table in a database; each record in said database contains fields for storing a single alphanumeric text message and editable fields that are specifically set aside for the storage of user entered notation and grouping tags that can be searched upon by the user.

2. The stored records containing stored E-communication according to claim 1, wherein the mobile device user can enter information in the form of alphanumeric strings into one of the editable fields that are specifically set aside; the information entered is stored and viewable to the user; the “Annotation” field holds user entered information about the message stored in the record; whenever a message stored in records on the mobile device is viewed the viewer will be able to see any additional information that is stored in the annotation field of said record; the content of the annotation field can be search by the user.

3. The stored records containing stored E-communication according to claim 1, wherein the mobile device user can enter an identification tag consisting of alphanumeric characters in one or more strings in to the editable fields that are specifically set aside to hope user create identifying tags; the “Group” field holds user entered identification tag that can be used to link unrelated E-communications; whenever a search of the “Group” is executed, all Ecommunications with the same tag will be gathered together for display to the user of the mobile device.

4. The stored records in a mobile device containing stored E-communications according to claim 3, said records possessing a time-calendar-trig field that is interacting with the mobile device clock-calendar is able to trigger an alert notification that displays said Ecommunication record when the said mobile device clock calendar matches the time-calendartrig field stored content, said alert will display record and allow user to access any additional records in the table that contain the same alphanumeric text contents in their “Group” field as the record that the alert was triggered on.

5. A method, comprising: converting the contents of each E-communication into data that can be stored in fields of a table on a mobile device and said record fields can be edited and searched by the user of said mobile device.

6. The method of claim 5, wherein the contents of specific fields in any record in the table can be edited to contain an alphanumeric string that can be searched for, and results of said search is a retrieval of all records with the same alphanumeric string in said specific field as searched.

7. The method of claim 5, wherein the contents of specific fields in any record in the table can be edited to contain a calendar date and a time of day that can be searched for, and results of said search is a retrieval of all records with the same alphanumeric string in said specific field as searched.

8. The method of claim 6, wherein a unrelate E-communications can be links to one another by placing the same alphanumeric string in the same specific field of a record, allowing a search of the table to result in the retrieval of all records with the same alphanumeric string in said specific field.

9. The method of claim 8, wherein the content of a field in a record can alert the user of the mobile device to review received and stored E-communication.

10. The method of claim 8, wherein the content of a record can alert the user of the mobile device to review received and stored E-communication that is linked to other stored E-communications stored on said mobile device.

11. The method of claim 5, wherein the content of E-communication stored in records of a table can be searched by a variety of criteria.

12. The method of claim 5, wherein the content of E-communication stored in records of a table can be searched by a combination of criteria.

13. A method for enriching the value of messages stored on a mobile device by addition of notes by the user to increase the understanding of said messages comprising: software on a mobile device for storing the contents of each E-communication message individually into searchable fields of a record in a table of a database; each said record also contains additional blank fields that the user can enter, edit and save alphanumeric string(s) and a calendar date-time; and said fields of the stored record can be search by the mobile device user.

14. The method of claim 13, wherein the messages stored on the mobile device in a record of a database can be sent and received text message or a received Email message.

15. The method of claim 14, wherein any given alphanumeric string can be placed in a specific field of any record selected by the user of the mobile device regardless of the origin of said record content; a search executed on said alphanumeric string will gather and display all of the records with the same alphanumeric string in the specific field searched.

16. The method of claim 15, wherein any given alphanumeric string can be used to search multiple fields of stored records of the table of the database regardless of the content origin of the records; a display of the records found to have match the searched.

17. The method of claim 16, wherein descriptive alphanumeric text relating to the contents of the E-communication stored in the record can be entered by a user and stored in an annotation field of the records stored in a table in the database; said annotation fields of the records can be searched by the user; all records that contain a match to the search upon criteria will be display to the user; the display will include both the text content of the E-communication and the annotation that contains a match to the searched on criteria.

18. The method of claim 16, wherein the contents stored in the annotation fields of the records in the database can be searched by the user; all records that match the search upon criteria will be display to the user; the display will include both the text content of the message and the annotation.

19. The method of claim 18, wherein another one of the specifically set aside editable fields can be filled with an alphanumeric string that serves as a tag that can be searched upon; and if multiple record have the same tag in the same field, the tag will act as a link that will allow the search to pull up un-related records regardless of their content or origin if the record has a matching tag.

20. The method of claim 19, wherein the mobile device user can store a specific alphanumeric string in another one of the specifically set aside editable fields of records that contain the stored contents of messages; the field is a tag field that a specific search can be executed upon; the alphanumeric string stored in said tag field will serve as an identifying tag that can be used as a searchable variable that can link un-related communication stored in the same table of a database; when the user execute a search upon the tag field with a specific alphanumeric string messages containing a match to said specific alphanumeric string will be gathered and displayed.
